(19) United States
(12) Patent Application Publication
(10) Pub. No.: US 2014/0204200 A1
(43) Pub. Date: Jul. 24, 2014

(54) METHODS AND SYSTEMS FOR SPEED CALIBRATION IN SPECTRAL IMAGING SYSTEMS

(71) Applicants: Upendra Suddamalla, Kadiri (IN); Anandaraj Thangappan, Bangalore (IN)

(72) Inventors: Upendra Suddamalla, Kadiri (IN); Anandaraj Thangappan, Bangalore (IN)

(73) Assignee: Wipro Limited, Bangalore (IN)

(21) Appl. No.: 13/792,901

(22) Filed: Mar. 11, 2013

(30) Foreign Application Priority Data
Jan. 24, 2013 (IN) 341/CHE/2013

(51) Int. Cl. H04N 17/00

(52) U.S. Cl. CPC H04N 17/002
USPC 348/92

(57) ABSTRACT

This disclosure generally relates to spectral imaging and, more particularly, to methods and systems for speed calibration in spectral imaging systems. In one embodiment, a spectral imaging system is disclosed, comprising: an imaging sensor configured to acquire image data for an imaged object; a multi-band wavelength filter disposed to filter light detected by the imaging sensor; and a motion stage configured to cause relative motion between the imaged object and the multi-band wavelength filter at a motion rate that is based on a frame rate of the imaging sensor and a number of wavelength bands of the wavelength filter utilized to filter light detected by the imaging sensor; wherein the motion rate is set such that light detected by the imaging sensor corresponding to a portion of the imaged object is filtered by successive wavelength bands of the wavelength filter for successive frames capturing the portion of the imaged object.

### PRIORITY CLAIM

This disclosure claims priority under 35 U.S.C. §119 to: India Application No. 341/CHE/2013, filed Jan. 24, 2013, and entitled “SPEED CALIBRATION IN A SPECTRAL IMAGING SYSTEM.” The aforementioned application is incorporated herein by reference in its entirety.

### TECHNICAL FIELD

This disclosure generally relates to spectral imaging and, more particularly, to methods and systems for speed calibration in spectral imaging systems.

### BACKGROUND

Spectral imaging systems have applications in fields such as agriculture, mineralogy, scientific research, chemical imaging, and surveillance. Increasingly, such systems are used in high-end applications such as machine vision to control quality of materials and products. Spectral imaging systems obtain spectral information with high spatial resolution from a two dimensional (2D) image of an object and provide a digital image with more spectral (color) information for each pixel than conventional color cameras. Additionally, spectral imaging systems can access spectral regimes such as infrared, which enable machine vision systems to exploit reflectance differences that do not fall within the visible spectrum. The raw data output may be visualized as a “data cube,” made up of a stack of images, with each successive image representing a specific color (spectral band). The two dimensions of the data cube represent the physical dimensions of the imaged object (e.g. length and breadth) and the third dimension represents the wavelength information associated with each point on the imaged object.

### SUMMARY

In one embodiment, a spectral imaging system is disclosed, comprising: an imaging sensor configured to acquire image data for an imaged object; a multi-band wavelength filter disposed to filter light detected by the imaging sensor; and a motion stage configured to cause relative motion between the imaged object and the multi-band wavelength filter at a motion rate that is based on a frame rate of the imaging sensor and a number of wavelength bands of the wavelength filter utilized to filter light detected by the imaging sensor; wherein the motion rate is set such that light detected by the imaging sensor corresponding to a portion of the imaged object is filtered by successive wavelength bands of the wavelength filter for successive frames capturing the portion of the imaged object.

It is to be understood that both the foregoing general description and the following detailed description are exemplary and explanatory only and are not restrictive of disclosed embodiments, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary scheme for obtaining spectral images of an object according to some embodiments of the present disclosure.

FIG. 2 illustrates an exemplary spectral imaging system according to some embodiments of the present disclosure.

FIG. 3 is a functional block diagram according to some embodiments of the present disclosure.

FIG. 4 illustrates the arrangement of wavelength bands of the multi-band wavelength filter 220 over the pixels of the imaging sensor 210, in accordance with some embodiments of the present disclosure.

FIG. 5 is a flow diagram illustrating an exemplary motion rate calibration method in accordance with some embodiments of the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

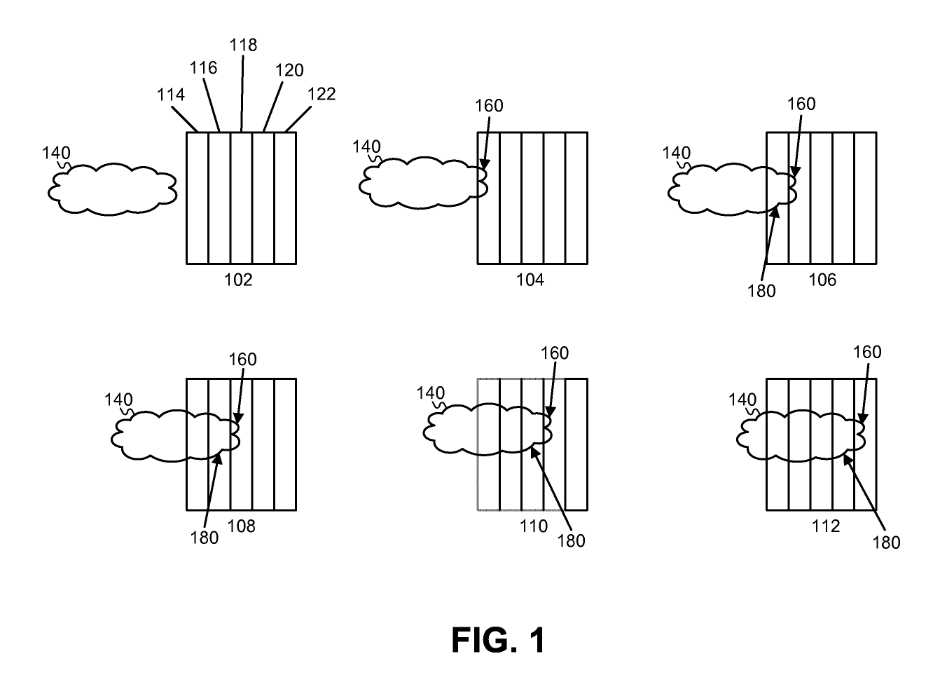

FIG. 1 illustrates an exemplary scheme for obtaining spectral images of an object according to some embodiments of the present disclosure. In some embodiments, a camera may use a multi-band wavelength filter to acquire spectral images of an object 140. For example, the multi-band wavelength filter may be comprised of a number of wavelength bands, e.g., 114, 116, 118, 120, 122. Each wavelength band may be configured to filter a particular band of electromagnetic (e.g., optical) wavelengths. An object 140 illuminated with light (e.g., from a white light source) may provide a response (reflectance, fluorescence, phosphorescence, etc.). The response may be filtered by one or more bands of the multi-band wavelength filter before being captured by the camera. In some embodiments, the spectral imaging system may cause relative motion between either: (1) the object and the filter; (2) the object and the camera; or (3) the filter and the camera. For example, the spectral imaging system may utilize a transport system such as a translation stage, a rotation stage, etc. to cause the relative motion. During such relative motion, the camera may acquire one or more image frames of the object through the filter. Due to the relative motion, the response of portions of the object 140 may be filtered by different wavelength bands of the filter before being captured in frames acquired by the camera. Further, each portion's response may be filtered by different wavelength bands before being captured in different frames acquired by the camera. For example, with reference to FIG. 1, in frame 104 acquired by the camera, the response of a first portion 160 of the object 140 may be filtered by band 114. In frame 106, the response of the same first portion 160 of the object 140 may be filtered by band 116 due to relative motion between the object 140 and the camera or filter (the camera and filter are stationary with respect to each other in this exemplary embodiment). In addition, in frame 106, the response of a second portion 180 of the object 140 may be filtered by band 114. Similarly, due to relative motion between the object 140 and the camera, the response of different portions of the object 140 are filtered by the different bands of the filter before being captured in frames 108, 110, and 112. From the frames 104, 106, 108, 110 and 112, etc., the spectral response of the object 140 can be reconstructed by rearranging the pixels from the different frames according to the portions of the object to which they relate. For example, in the scheme depicted by FIG. 1, the captured spectral response of the first portion 160 of the object 104 can be reconstructed from the pixels filtered by: wavelength band 114 in frame 104, wavelength band 116 in frame 106, wavelength band 118 in frame 108, wavelength band 120 in frame 110, and wavelength band 122 in frame 112. Similarly, the captured spectral response of the second portion 180 of the object 140 can be reconstructed from the pixels filtered by: wavelength band 114 in frame 106, wavelength band 116 in frame 108, wavelength band 118 in frame 110, and wavelength band 120 in frame 112 (capturing of the response of the second portion 180 of the object 140 after filtering by wavelength band 122 is not shown in FIG. 1). Other portions of object 140 that are not numerically identified in FIG. 1 may similarly become reconstructed from the pixels filtered by: wavelength band 114, 116, 118, 120, 122, etc. upon passing through frames 104, 106, 108, 110 and 112, etc.

In some embodiments, frames 104, 106, 108, 110, and 112 are successive frames captured by the camera such that additional frames captured in between any of these frames do not provide additional spectral response information not already collectively present in these frames. In other situations, however, the response of the object 140 may be over- or under-sampled, leading to distortions in the acquired spectral image. For example, in some situations, the rate at which object 140 is moved may be slower than needed to create the above-mentioned preferred embodiment, causing oversampling of the response of the object 140. This is because slow movement of the object 140 will lead to the capture of additional frames in between the frames that are like the frames 104, 106, 108, 110, and 112. In other situations, the rate at which object 140 is moved may be faster than required to capture the frames 104, 106, 108, 110, and 112. For example, if the first portion 160 of the object 140 is moved, between successive frames, by a distance greater than the width of a wavelength band (assuming, in this example, that the wavelength band widths are all of equal length and measured in number of pixels), the response from parts of the first portion 160 of the object 140 may not become properly sampled by all the wavelength bands of the filter. This would lead to an incomplete spectral response of the first portion 160 of the object 140. Accordingly, in other embodiments, the rate of the relative motion may be calibrated according to the frame rate of the camera. In still other embodiments, the motion rate calibration method uses reference patterns of known size to calibrate the relative motion rate. Further, the motion rate calibration method uses sensor properties of the camera to calibrate and dynamically adjust the motion rate. The reference patterns may be any standard computer vision calibration pattern, like a grid, cross line patterns, circles, USAF 1951 resolution target, etc., satisfying industry-accepted specifications (e.g., MIL SPEC).

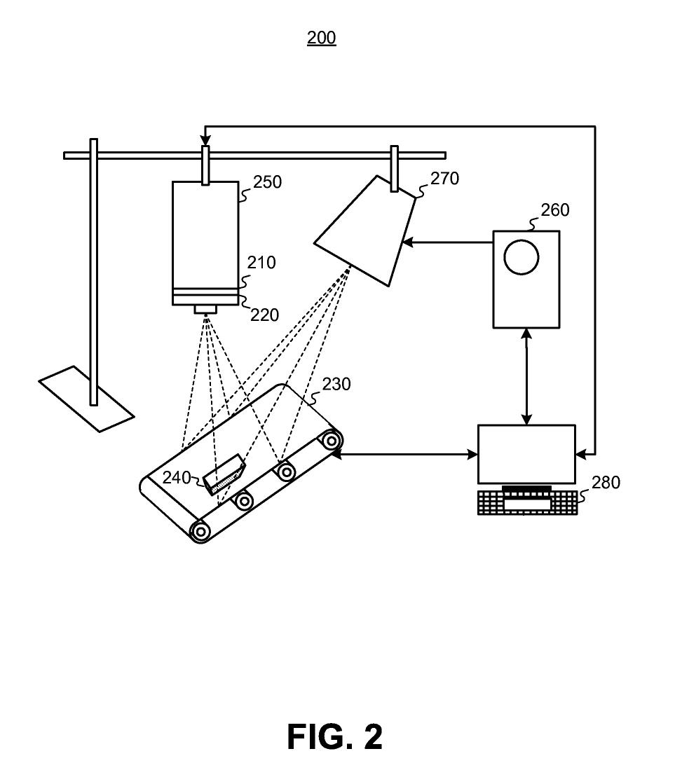

FIG. 2 illustrates an exemplary spectral imaging system 200 according to some embodiments of the present disclosure. The spectral imaging system 200 may be a multi-spectral imaging system or a hyper-spectral imaging system. The distinction between such systems may be based on an arbitrary number of bands. For example, hyper-spectral imaging may include capturing the object's response over a large number of narrow, contiguous, spectral bands, whereas multi-spectral imaging may include capturing the object's response over broader, and perhaps non-contiguous, spectral bands.

The spectral imaging system 200 may include: an imaging system 250, a lighting system 270, and a control system 280, in addition to the transport system 230 configured to move the object 240. In alternate embodiments, the transport system 230 may be configured to transport the imaging system 250, or components included in the imaging system 250, such as an imaging sensor 210 or a multi-band wavelength filter 220. It should be understood that although a single object 240 is illustrated, other embodiments may include a stream of objects to be scanned, appearing on the transport system 230 serially or in parallel (e.g., such that they may be imaged within the same frame(s)).

The imaging system 250 may be embodied as a stare-down camera, mounted for clear observation of the object 240. Examples include still cameras, digital cameras, charge-coupled devices (CODs), complementary metal-oxide semiconductor (CMOS) sensors, etc., though persons of skill in the art will understand that a variety of imaging devices are readily available. Positioning the imaging system 250 may be governed by the particular characteristics of the installed system and the operating environment, such as the optimal distance above the scanned object for mounting the camera, as well as the characteristics of the object 240 itself.

Components of the imaging system 250 may include an imaging sensor 210, a multi-band wavelength filter 220, and a transport system 230. The imaging sensor 210 may produce an optical image of the object 240 employing conventional optical lenses or the like, and then focus that image on an electronic capture device, such as a digital Charge-Coupled Device (CCD) or Complementary Metal-Oxide-Semiconductor (CMOS) active pixel sensor. Similar devices may also be employed. Imaging sensor 210 may include an array of pixels having ‘r’ pixel rows and ‘p’ pixel columns.

The multi-band wavelength filter 220 may include a large variety of color filters placed over the pixel sensors of the imaging sensor 210, disposed to filter light detected by the imaging sensor 210. In some embodiments, this device may be attached to the imaging sensor 210 or formed directly on the imaging sensor 210 using semiconductor micro-fabrication techniques. Wavelength bands, such as bands 114, 116, 118, 120, 122 of FIG. 1, may be arranged such that each wavelength band covers a set of successive pixel rows on the imaging sensor 210. In some embodiments, each wavelength band may filter light detected by equal numbers of pixel rows of the imaging sensor 210. For example, each wavelength band may filter light detected by five pixel rows of the imaging sensor. In some embodiments, each wavelength band may filter light detected by a single pixel row of the imaging sensor. Further, in some embodiments, the imaging sensor 210 and the multi-band wavelength filter 220 may be located within an imaging system 250.

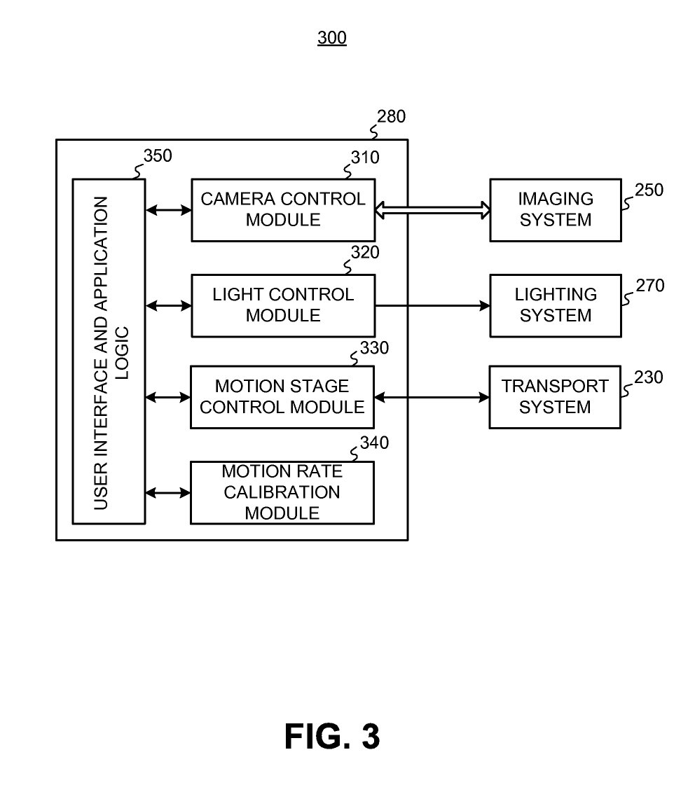

In some embodiments, the transport system 230, which may be embodied as a conveyor belt, may move the object 240 through the viewing field of imaging sensor 210. Here, transport system 230 may cause translation motion of the object. In alternate embodiments, either the object or imaging sensor may be moved, and the movement may be translational, rotational, helical, etc. For example, rotational motion of a filter may be accomplished using a color wheel filter. It should be understood that any type of motion may be combined with motion of any particular component to accomplish relative motion resulting in the response of a part of the imaged object being captured in different frames after being filtered by different bands of the multi-band wavelength filter. In some embodiments, such as those where the object is moved, the object's velocity—normally stated as distance traveled over a unit of time—may also be expressed in terms of the imaging parameters of imaging sensor 210. For example, instead of millimeters per second, spectral imaging system 200 can measure the number of wavelength bands of the multi-band wavelength filter 220 traversed in a given time, or a number of pixels of the imaging sensor 210 traversed in a given time. Thus, a number of imaging sensor parameters may be implicated in the analysis, including imaging sensor resolution, the number of pixel lines in the sensor, and/or the ‘realunits2pix’ value of the sensor (defined as the real-world distance (e.g., mm) covered by one pixel of the imaging sensor). These factors are explained in detail in connection with FIGS. 3, 4, and 5, below.

In the embodiment of FIG. 2, the transport system 230 may cause translational motion of the imaged object 240. As shown in FIG. 2, the transport system 230 may move the imaged object 240 under the imaging system 250. Alternatively, the transport system 230 may cause the motion of the multi-band wavelength filter 220. For example, some embodiments of the present disclosure could be mounted in an aircraft to perform, for example, aerial photography or reconnaissance. In such some embodiments, where the relative motion rate is an independent variable or otherwise not modifiable, synchronicity may be achieved by controlling the frame rate instead. For example, as the velocity of the aircraft increases, in effect, the motion rate of the multi-band wavelength filter increases, and therefore the frame rate may be correspondingly increased to achieve synchronicity.

Additionally, in some embodiments, the spectral imaging system 200 may employ a lighting system 270, including a conventional device to direct light toward the object 240, such as a hood, as well as a light source 260. This system may uniformly illuminate the field of view of the imaging sensor 210, providing a consistent light intensity over a wide spectral range. Further, a control system 280 may control and monitor the spectral imaging system 200. The control system 280 may be integrated with the imaging system 250, the transport system 230, and/or the lighting system 270. Appropriate user interfaces, as well known in the art, may facilitate use of the system, as explained in connection with FIG. 3, below.

FIG. 3 is a functional block diagram 300 of the spectral imaging system 200. Similar to the embodiments described above in connection with FIG. 2, the spectral imaging system 300 may include imaging system 250, lighting system 270, control system 280, and transport system 230. Further, the control system 280 may include a camera control module 310, a light control module 320, a transport system control module 330, a motion rate calibration module 340, and user interface and application logic 350.

Camera control module 310, light control module 320, and/or transport system control module 330 may be employed to control one or more aspects of imaging system 250. The camera control module 310 may also store information about properties of the imaging sensor 210, including the frame rate (FrameRate), the number of pixel rows (SRows), the number of pixel columns (SCols), and information about properties of the multi-band wavelength filter 220, such as the number of wavelength bands (NBands). Similarly, the light control module 320 may store information such as intensity of the light source 260 (see, e.g., the description associated with FIG. 2, supra). The motion rate calibration module 340 may determine the relative motion rate between the imaged object and a multi-band wavelength filter, as described in detail below. That motion rate may then fed to and stored in the transport system control module 330 which controls the movement of the transport system 230.

Further, the functioning of the camera control module 310, the light control module 320, the transport system control module 330 and the motion rate calibration module 340 may be completely automatic or semi-automatic. The user interface and application logic 350 may allow a user to configure and control the modules.

In some embodiments, the modules may be located within the individual components instead of in one or more centralized locations, as may be the case in alternate embodiments. For example, the camera control module 310, the light control module 320, and the transport system control module 330 may be placed within the imaging system 250, the light source 260 and the transport system 230, respectively. Similarly, the motion rate calibration module 240 may be placed in the transport system 230.

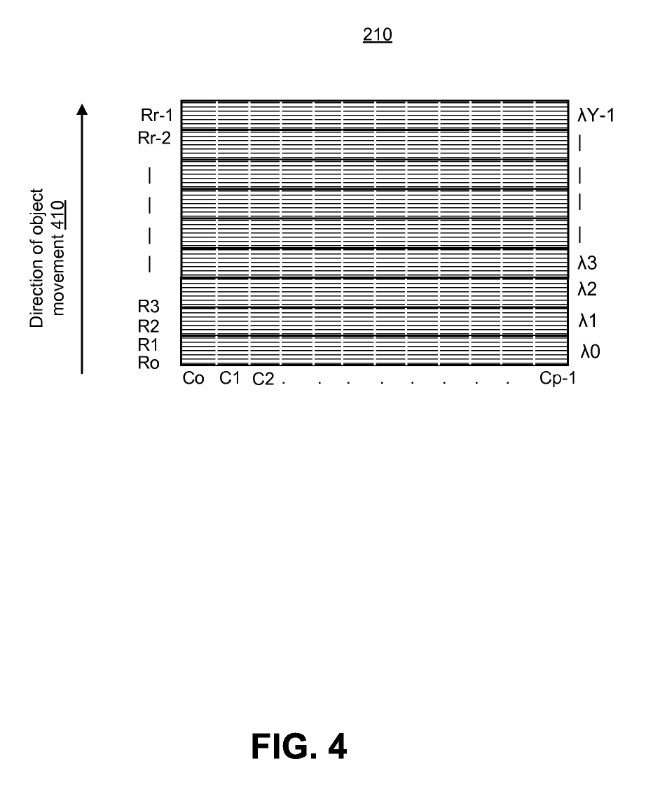

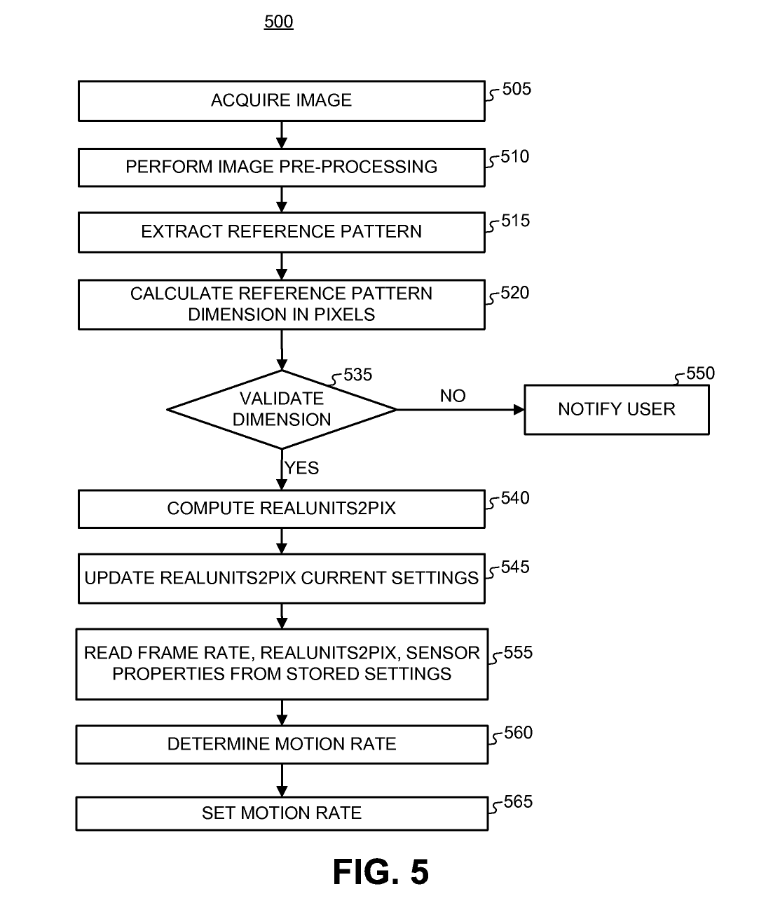

FIG. 4 illustrates the arrangement of wavelength bands of the multi-band wavelength filter 220 over the pixels of the imaging sensor 210, in accordance with some embodiments of the present disclosure. The imaging sensor 210 may include an array of digital pixels having ‘r’ (R₀, R₁, . . . Rᵣ₋₁) pixel rows (SRows) and ‘p’ (C₀, C₁, . . . Cₚ₋₁) pixel columns (SCols). The number of pixel rows (SRows) or pixel columns (SCols) may define the imaging sensor resolution of the imaging sensor 210. The multi-band wavelength filter 220 may include a number of wavelength bands (NBands), where each wavelength band is sensitive to a particular wavelength or wavelength range chosen from a set of wavelengths (λ₀-λ_{Y-1}) (or wavelength ranges). That filter may be disposed relative to the imaging sensor 210 in such a way that a set of ‘x’ successive pixel rows are covered by a particular wavelength band. The pixel rows R₀ to Rₓ₋₁ may be covered by a wavelength band corresponding to wavelength λ₀. Similarly, the pixel rows Rₓ to R₂ₓ₋₁ may be covered by a wavelength band corresponding to wavelength λ₁ and so on, till the pixel rows Rᵣ₋ₓ₋₁ to Rᵣ₋₁ are covered by the last wavelength band corresponding to wavelength λ_{Y-1}. The image sensor properties, such as SRows(r), SCols (p), and NBands (Y), may be used to determine the motion rate of the transport system 130, as explained in FIG. 5 with further detail.

In some embodiments, the object 140 (see FIG. 1) may be passed through each and every wavelength band (λ₀ to λ_{Y-1}) in successive frames of data acquisition. The resulting images may then be used to generate the spectral data cube. The direction of motion of the imaged object 140 is shown by an arrow 410, as explained in connection with FIG. 4 below. In some embodiments, due to manufacturing constraints of the filter, there may be a few invalid bands. However, for ease of discussion it may be assumed that all the bands (valid or invalid) are equally spaced so that the motion rate is uniform throughout data acquisition process.

FIG. 5 is a flow diagram illustrating an exemplary motion rate calibration method 500 that may be used by the spectral imaging system 200 of FIG. 2 to calibrate the motion rate. The control system 280 may set up the spectral imaging system 200. This may include setting up the imaging system 250, lighting system 270, and transport system 230. In each instance, these setup activities may be aimed to meet specific application requirements.

One or more reference points or objects or patterns of known length and/or size and/or dimension may be used to calibrate the motion rate. If the distance and/or position of the imaged object 140 with respect to the multi-band wavelength filter 220 is known, then for motion rate calibration, the reference pattern may be located at the same distance and/or position from the multi-band wavelength filter 220. For example, if the imaged object 140 is placed on a conveyor belt as shown in FIG. 2, then the reference pattern may also be placed on the conveyor belt. The light control module 320 may set the light intensity value to a predefined value at which the reference pattern is clearly visible across all the relevant wavelengths.

At step 505, the imaging sensor may acquire a single frame of the reference pattern. Multiple frames of the reference pattern may also be used. At step 510, the camera control module 310 may perform image pre-processing. Image pre-processing may include illumination variation correction, perspective correction, and lens distortion correction. The acquired image may include image data of the reference pattern along with the image data of the surrounding area, and therefore, at step 515 spatial registration may be used on the acquired image to extract the known reference pattern. Spatial registration may become accomplished according to a variety of means known to persons of skill in the art. Depending on the reference pattern, spatial registration can be performance by pattern recognition or shape fitting techniques. For example, the Hough transformation can be used to detect circular reference patterns in the image. The spatial registration may serve to match features in the acquired image with the known reference pattern and allow the image of the reference pattern to be extracted. At step 520, the dimensions of the extracted reference pattern may be calculated, which may then be validated at step 535. Validation of the dimensions may be based on, for example, whether the image provided sufficient information to allow extraction of the reference pattern, whether the calculated dimensions fall within a pre-determined range, etc. If the dimensions can be successfully extracted (which may not be the case if the image is dull or blurred), and if the dimensions are considered valid (which may not be the case if the dimensions exhibit distortions such as aspect ratio modification), the procedure may continue. Dimensions may be validated by, for example, computing multiple attributes (e.g., size, distances, length, width, etc.), and validating their relationships with known relations. For example, if the reference pattern is a dot grid, the distance between the dots at the four corners may be computed, and the center-to-center distances between successive corner dots may be validated. If the dimensions are found to be valid, at step 540, the motion rate calibration module 340 may compute the sensor spatial resolution (realunits2pix) as the dimensions of the registration pattern in real-world units (e.g., mm) divided by the number of pixels covered in the image by that dimension, yielding, for example, a mm/pixel value. For example, the reference pattern may include registration marks with a known length (say, for example, 50 mm) between the marks. The spatial registration algorithm, when applied to the acquired image, may extract the reference pattern, and identify that a certain number of pixels (say, for example, 20 pixels) on the imaging sensor 210 cover the length between the marks. Using at least this information, at the step 560, the sensor spatial resolution (realunits2pix) may be computed (in the example above, as 2.5 mm/pixel (=50 mm/20 pixels)).

At step 545 the computed sensor spatial resolution may be updated in one or both of the motion rate calibration control module 340 and the transport system control module 330. However, if the dimensions are found to be incorrect at step 535, then at step 550, the application logic 250 may notify a user by means of the user interface of the error. Thereafter, automatic or manual corrective steps may be performed. Probable failure cases may be due to reference object quality, captured image quality, etc. Notification messages may provide actions that are required by the user before repeating steps 505-520. As a fallback option, a manual mode of calibration may also be supported.

At step 555, once the motion rate is calibrated, the motion rate calibration control module 340 may obtain the FrameRate,SRows SCols and NBands variables from the camera control module 310. At step 560, the motion rate calibration control module 340 may determine the motion rate (‘R’) required for loss-less data acquisition using the following equation:

$$R = FrameRate \times ( \frac{SRows}{NBands} ) \times realunits 2 pix \qquad ( 1 )$$

For example, if FrameRate is 24 fps, SRows is 1024 pixels/frame, NBands is 64, and realunits2pix is 0.5 mm/pixel, motion rate (R) may be calculated using equation (1) as: R=24 frames/sec*(1024/64) pixels/frame*0.5 mm/pixel=192 mm/sec

The motion rate calibration control module 340 may store the determined motion rate at the transport system control module 330. At step 565, the transport system control module 330 may set the motion rate of the transport system 230 according to the determined motion rate. In some embodiments, the motion rate calibration module can periodically re-assess the determined motion rate, and adjust the motion rate of the transport system 230 in real-time during the imaging procedure. In alternate embodiments, additional calibration may not need to be performed even as the imaging system's frame rate changes. Instead, the motion rate R for any given frame rate may be dynamically calculated using a calibration factor as the motion rate R is directly proportional to the frame rate FrameRate according to equation (1).

The subsequent steps of image acquisition, data cube preparation and spectral data analysis may be performed using various techniques as per suitability and requirements of the application. In some embodiments, the spectral imaging system 200 may include one or more hardware processors, field-programmable gate arrays (FPGAs), hardware chips designed using VHDL or Verilog, and/or the like, that perform various operations, including obtaining the image data for the imaged object from the imaging sensor, generating pixel-resolution wavelength-dependent response data for the imaged object and outputting the pixel-resolution wavelength-dependent response data. In further embodiments, one or more hardware processors may generate user interface data for the user interface to allow a user to modify the motion rate. A display device may be operatively connected to the one or more hardware processors to display the user interface data. In some embodiments, one or more components of spectral imaging system 200, such as computing device 180, may include the one or more hardware processors used to perform operations consistent with disclosed embodiments, including those performed by the modules described with respect to FIG. 3, supra.

Consistent with other disclosed embodiments, tangible computer-readable storage media may store program instructions that are executable by the one or more processors to implement any of the processes disclosed herein. For example, spectral imaging system 200 may include one or more storage devices configured to store information used by the one or more processors (or other components) to perform certain functions related to the disclosed embodiments. In one example, computing device 180 may include one or more memory devices that include instructions to enable the one or more processors to execute one or more software applications consistent with disclosed embodiments. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer readable medium.

The specification has described systems and methods to perform motion rate calibration in a spectral imaging system. The illustrated steps are set out to explain the embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. It is intended that the disclosure and examples be considered as exemplary only, with a true scope and spirit of disclosed embodiments being indicated by the following claims.

What is claimed is:

1. A spectral imaging system, comprising:
an imaging sensor configured to acquire image data for an imaged object;
a multi-band wavelength filter disposed to filter light detected by the imaging sensor; and
a motion stage configured to cause relative motion between the imaged object and the multi-band wavelength filter at a motion rate that is based on a frame rate of the imaging sensor and a number of wavelength bands of the wavelength filter utilized to filter light detected by the imaging sensor.

2. The system of claim 1, wherein the motion rate is set such that light detected by the imaging sensor corresponding to a portion of the imaged object is filtered by successive wavelength bands of the wavelength filter for successive frames capturing the portion of the imaged object.

3. The system of claim 2, wherein the motion rate is further based on an imaging sensor resolution and a sensor spatial resolution.

4. The system of claim 3, wherein the motion rate is determined as:
$$R = FrameRate \times ( \frac{SRows}{NBands} ) \times realunits 2 pix ,$$
wherein R is the motion rate, FrameRate is the frame rate of the imaging sensor, SRows is the imaging sensor resolution, NBands is the number of wavelength bands of the wavelength filter utilized to filter light detected by the imaging sensor, and realunits2pix is the sensor spatial resolution.

5. The system of claim 4, wherein the imaging resolution is measured based on spatial registration of a reference pattern image captured via the imaging sensor.

6. The system of claim 3, wherein the wavelength filter is configured such that each of the number of wavelength bands filters light detected by equal numbers of the pixel lines of the imaging sensor.

7. The system of claim 6, wherein each of the number of wavelength bands filters light detected by one pixel line of the imaging sensor.

8. The system of claim 1, wherein the motion stage is configured to cause motion of the imaged object.

9. The system of claim 1, wherein the motion stage is configured to cause motion of the multi-band wavelength filter.

10. The system of claim 9, wherein the multi-band wavelength filter is integrated with the imaging sensor.

11. The system of claim 1, wherein the motion stage causes relative translation between the imaged object and the multi-band wavelength filter.

12. The system of claim 1, further comprising:
a hardware processor configured to perform operations comprising:
obtaining the image data for the imaged object from the imaging sensor;
generating pixel-resolution wavelength-dependent response data for the imaged object; and
outputting the pixel-resolution wavelength-dependent response data.

13. The system of claim 1, further comprising:
a hardware processor configured to generate a user interface for a user to modify the motion rate; and
a display device operatively connected to the hardware processor to display the user interface for the user to modify the motion rate.
